(19) United States
(12) Patent Application Publication
(10) Pub. No.: US 2007/0076715 A1
(43) Pub. Date: Apr. 5, 2007

(54) Method for providing a multicast service within a wireless communications system

(76) Inventors: Markus Geor Bauer, Pegnitz Bavaria (DE); Hans Peter Schefczik, Erlangen (DE)

Correspondence Address: WILLIAMS, MORGAN & AMERSON, 10333 RICHMOND, SUITE 1100, HOUSTON, TX, 77042, US

(21) Appl. No.: 11/241,898

(22) Filed: Sep. 30, 2005

(51) Int. Cl. H04L 12/56

(52) U.S. Cl. 370/390; 370/401

(57) ABSTRACT

A method for implementing an internet protocol multicast service in a wireless communications system is provided. The method comprises receiving content from an internet protocol multicast server at a base station router; and passing the received content over an air interface to a mobile device.

### BACKGROUND OF THE INVENTION

1. Field of the Invention

This invention relates generally to telecommunications, and more particularly, to wireless communications.

2. Description of the Related Art

In the field of wireless telecommunications, new multicast services like video streaming, game delivery or news clips are becoming more and more popular on mobile handsets and user equipment (UE) like Personal Digital Assistants (PDAs) and notebooks. In today's 3G Universal Mobile Telecommunications System (UMTS), an efficient provision of such multicast services to a group of users is difficult, if not impossible. The difficulty arises from the fact that a simple unicast mode is used in an attempt to provide multicast services. The unicast mode, however, is extremely inefficient for this application, principally because the bandwidth in the backbone network of the UMTS is wasted. This waste arises from the fact that the amount of data that has to pass through the connected nodes towards the mobile handset increases dramatically the closer the node is to the content server.

Broadcast and multicast services are typically delivered in a point-to-point mode today. Unfortunately, this delivery method is un-scalable, and it cannot be implemented in current UMTS networks. Internet Engineering Task Force (IETF) standardized Internet Protocol (IP) multicast protocols (RFC1112) currently exist but are not applicable in the current UMTS R99/R4/R5 implementation without considerable enhancements in the UMTS network nodes. Thus, IP is commonly implemented using a point-to-point protocol in those 3G network architectures. To overcome these shortcomings, 3GPP is just now defining Multimedia Broadcast/Multicast Services (MBMS). However the MBMS standard (TS23.246, TS25.346) is not yet finalized and will be introduced in UMTS R6 in a basic form.

It is anticipated that the first implementation of the MBMS service architecture will not occur until the 2007/2008 timeframe. This is by far too late and not suited to stimulate 3G wireless network traffic today. Moreover the addition of the MBMS features to the current UMTS network architecture will have a significant impact on the existing network elements (NEs). All main UMTS network elements of the packet switched domain (UE, NodeB, RNC, SGSN, GGSN) need extensions for the MBMS context, which is costly for wireless operators and also for the end user. Furthermore a new network element—the Broadcast Multicast Service Center (BM-SC)—will be introduced for MBMS.

### SUMMARY OF THE INVENTION

The present invention is directed to overcoming, or at least reducing, the effects of, one or more of the problems set forth above.

In one aspect of the present invention, a method for implementing an internet protocol multicast service in a wireless communications system is provided. The method comprises receiving content from an internet protocol multicast server at a base station router; and passing the received content over an air interface to a mobile device.

### BRIEF DESCRIPTION OF THE DRAWINGS

The invention may be understood by reference to the following description taken in conjunction with the accompanying drawings, in which like reference numerals identify like elements, and in which:

FIG. 1 stylistically depicts an exemplary telecommunications system that implements an IP network Architecture using Base Station Routers (BSRs) over which efficient multicasting may take place;

FIG. 2 stylistically depicts an exemplary embodiment of an internet protocol multicast architecture that may be implemented within a telecommunications system of the type illustrated in FIG. 1;

FIG. 3 stylistically depicts interactions between the BSR, an air interface and a network interface of the telecommunications systems of FIGS. 1 and 2; and

FIG. 4 depicts a multicast service table that may be implemented in the BSRs of FIGS. 1 and 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Instead of waiting for the MBMS capable UMTS network elements, the instant invention uses IP multicast schemes in an access network of Base Station Routers (BSR) to provide multicast service delivery. Recent architectures under consideration tend to move all UMTS functionality into a single radio access node, e.g. a NodeB with integrated RNC, SGSN and GGSN in the case of UMTS is called a BSR. Such an IP based BSR access network is better suited for provisioning of multicast/broadcast features, as it can rely on already standardized and available multicast enabled IP routers.

There are several aspects of the instant invention, each of which tends to arise from the notion of a Base Station Router (BSR). The BSR moves away from a traditional centralized and hierarchical cellular architecture to a migratable distributed cellular architecture.

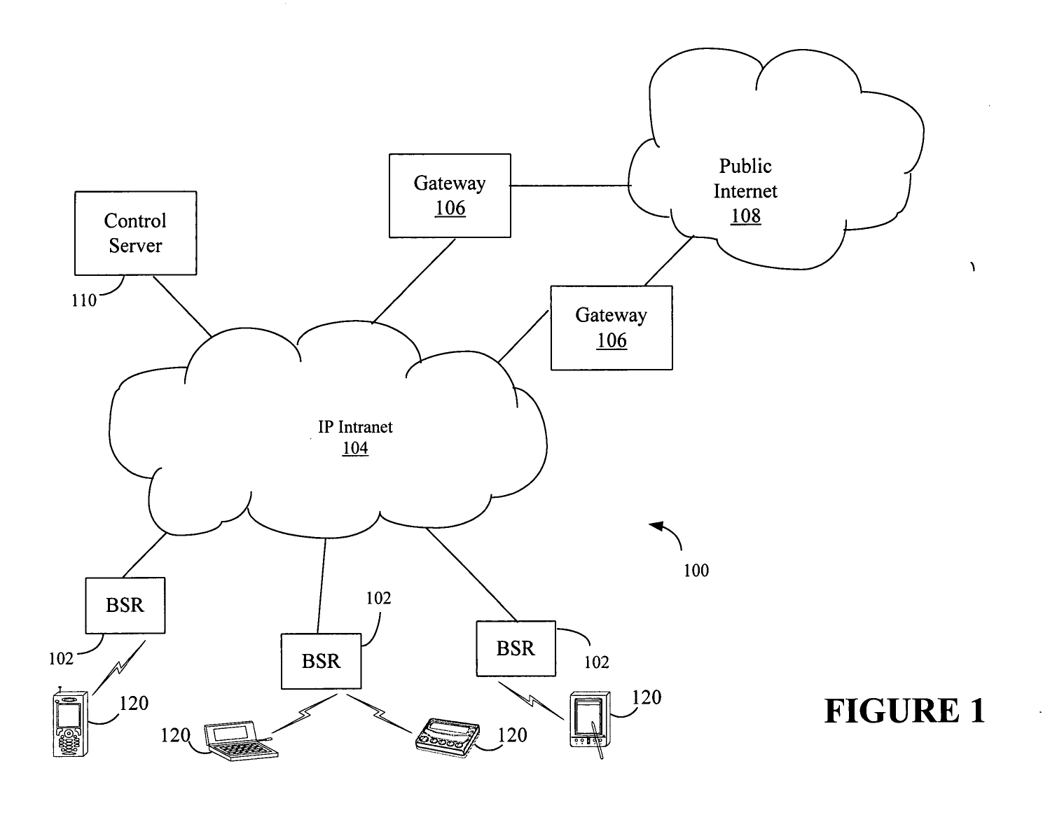

Turning now to the drawings, and specifically referring to FIG. 1, a communications system 100 employing an exemplary all-Internet Protocol (all-IP) network architecture is stylistically illustrated, in accordance with one embodiment of the present invention. Generally, the system 100 is comprised of a plurality of BSRs 102. The BSRs 102 are connected to an Intranet 104 (also referred to as the backhaul network). Gateways 106 connect the Intranet 104 to the Internet 108. In an exemplary embodiment of the instant invention, Internet Protocol (IP) is a network protocol that may be used to transport user and control information within the Intranet 104. A control server 110 provides call service control. One significant characteristic of the exemplary communications system 100 is that a substantial portion of the radio network functionalities are integrated with the base station functionalities, and are thus distributed across the network.

Third generation CDMA cellular networks are designed to support both voice and data services. Enhancements to packet data transport through high-speed shared channels (HSDPA in UMTS, EV-DV in CDMA 2000) are currently being standardized. In these systems, voice traffic is carried in traditional circuit-switched mode while data is carried through scheduled-mode shared channels in the form of packet switching. However, to provide a rich multimedia session, it is beneficial to have a single mode of transport for all services. This simplifies call control and reduces equipment cost for supporting multimedia user experience. Thus, for purposes of illustration, the instant invention is described in the context of a CDMA system that supports a shared transport channel, such as in the CDMA 2000 1x EV-DO system, as the wireless interface. Those skilled in the art will appreciate that aspects of the instant invention may be implemented in other types of communications systems without departing from the spirit and scope of the instant invention. Those skilled in the art will further appreciate that, whatever system is chosen to implement aspects of the instant invention, it would be useful for such a system to be capable of delivering the quality of service (QoS) required to carry multicast data.

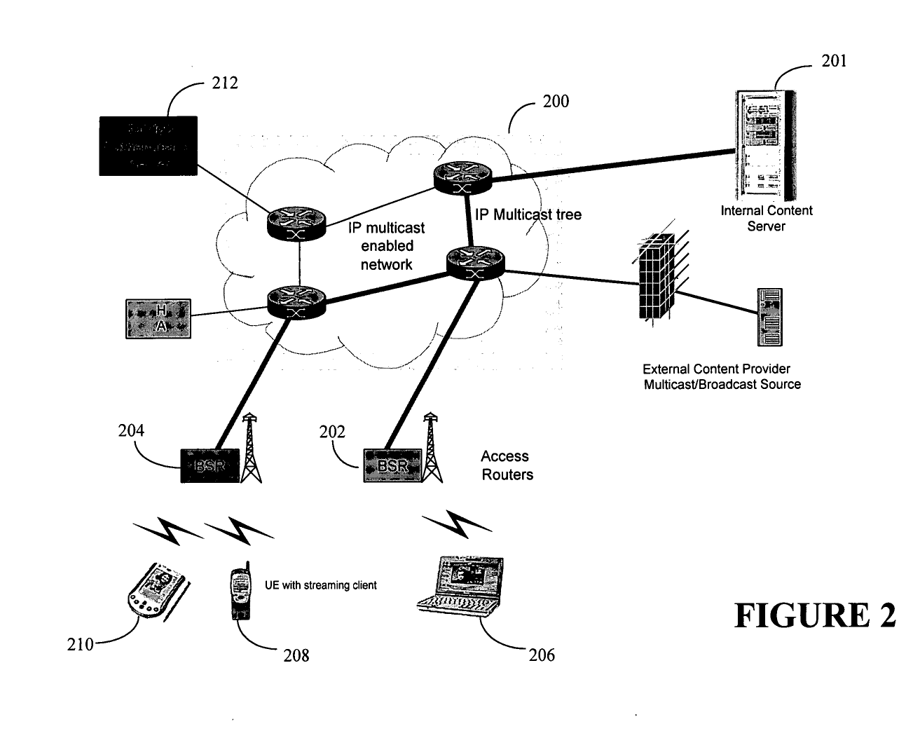

Turning now to FIG. 2, one embodiment of a BSR multicast architecture that may be employed by the instant invention is shown. FIG. 2 illustrates a multicast tree 200 for one multicast service for exemplary purposes. Also from Error! Reference source not found. it can be seen, that efficient IETF multicast functionality is used for service provisioning between a content server 201 and BSRs 202, 204. To map the multicast traffic onto an air interface between the BSRs 202, 204 and mobile devices 206, 208, 210, a new functionality is implemented in the BSRs 202, 204. This new functionality shall be referred to herein as “BSR Multicast/Broadcast Service Management Function” (MSMF).

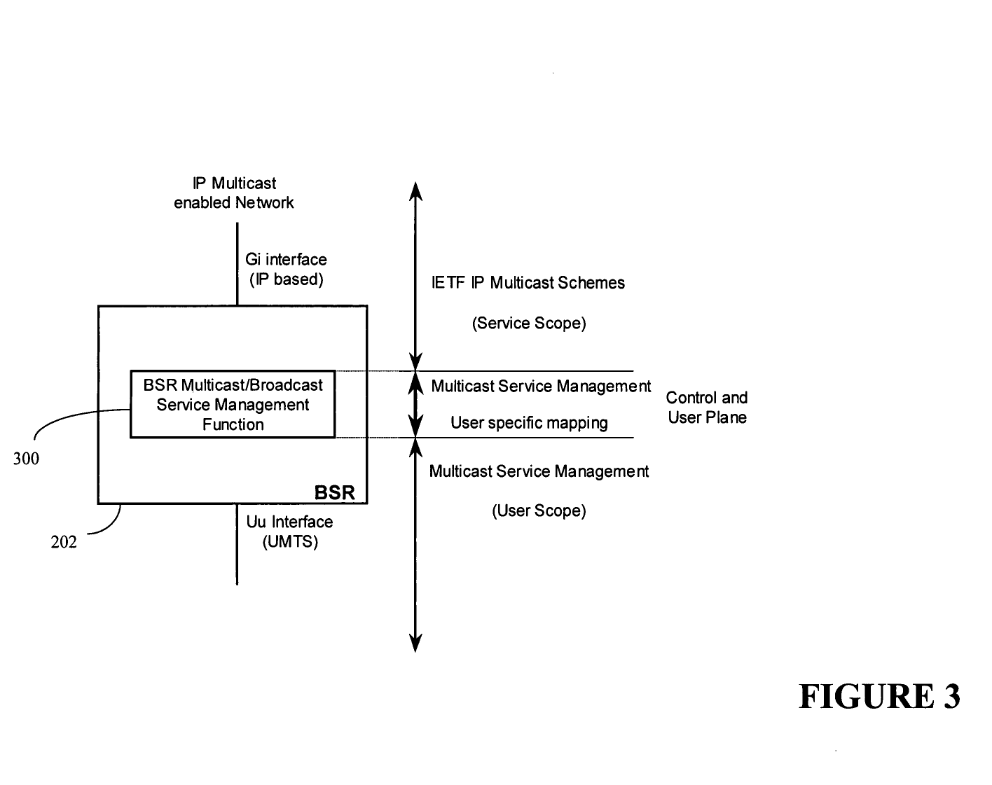

The scope of the MSMF 300 is depicted in FIG. 3. Generally, MSMF 300 provides a kind of proxy functionality between the air interface and the fixed network interface of the BSRs 202, 204. On the fixed network interface, the MSMF 300 operates with “Service Scope,” which generally means that the MSMF 300 is responsible for managing the registration of various available multicast services based on IETF multicast schemes (via Internet Group Management Protocol (IGMP) protocol messages: e.g., Join Group, Leave group, etc.). Generally, IP multicasting is defined as the transmission of an IP datagram to a “host group,” a set of hosts identified by a single IP destination address. A multicast datagram is delivered to all members of a host group with the same “best-efforts” reliability as regular unicast IP datagrams, i.e., the datagram is not guaranteed to arrive at all members of the destination group or in the same order relative to other datagrams. The membership of a host group is dynamic. That is, hosts may join and leave groups at any time. There is no restriction on the location or number of members in a host group, but membership in a group may be restricted to only those hosts possessing a private access key. A host may be a member of more than one group at a time. A host group may be permanent or transient. A permanent group has a well-known, administratively assigned IP address. It is the address, not the membership of the group, that is permanent. At any time, a permanent group may have any number of members, even zero. A transient group, on the other hand, is assigned an address dynamically when the group is created, at the request of a host. A transient group ceases to exist, and its address becomes eligible for reassignment, when its membership drops to zero.

On the air interface side of the BSRs 202, 204 MSMF operates with “User Scope,” such that the packets received for the different multicast services are mapped onto the various Radio Bearers of all users that have registered for the different multicast services with the MSMF.

To support the proxy functionality between the fixed network and the air interface, the MSMF maintains and coordinates service and user specific information. One exemplary embodiment of how this information and the corresponding functionality could be provided is discussed herein.

From a high-level perspective, there are two main information parts, which may be maintained by MSMF. First, MSMF maintains the multicast services for which the BSR 202 has registered on its fixed network interface. Second, MSMF maintains a listing of which attached mobile device 206, 208, 210 has registered for which service.

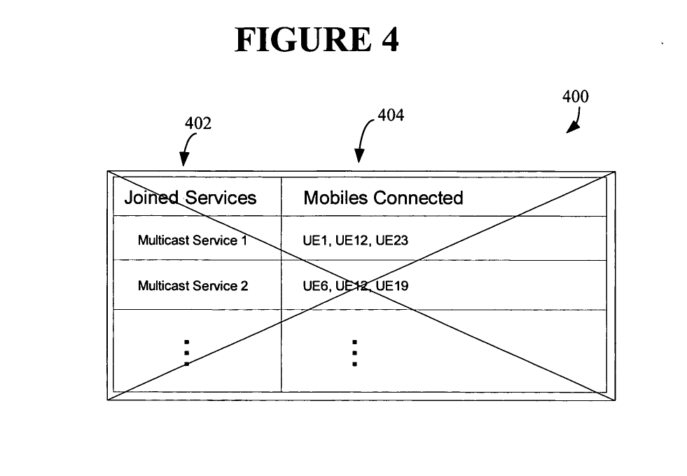

FIG. 4 illustrates a multicast service table 400, which maintains information that is used to perform the proxy function. The service table 400 consists of two columns 402, 404. In the first column 402, there is one entry for each multicast service (e.g., multicast service 1 and multicast service 2) for which the BSR 202 has registered on its fixed network interface. In the second column 404, the table identifies each mobile device 206, 208, 210 that has registered for each multicast service (multicast service 1 and multicast service 2). The MSMF ensures that each mobile device 206, 208, 210 will receive the content of its registered services by forwarding the incoming multicast service content onto the RABs of the registered user in an appropriate manner.

The table 400 is populated as follows: when a mobile device 206, 208, 210 wants to join a multicast service, it sends a “join multicast service” message to MSMF of the BSR with which it is connected. When MSMF receives such a message, it first checks whether the mobile device 206, 208, 210 is allowed to join that service. This is done by sending a “service for user allowed” message to a Service Authentication Server 212 (FIG. 2). This Service Authentication Server 212 checks whether the mobile device 206, 208, 210 is allowed to join the multicast service and sends back either a “user allowed to join” or “user not allowed to join” message. In case the user is not allowed to join, MSMF sends back a “service reject” message to the requesting mobile device 206, 208, 210. In case the requesting mobile device 206, 208, 210 is allowed to join, additional billing information elements are included into the “user allowed to join” message. With help from these billing information elements, MSMF charges the mobile device 206, 208, 210 for the requested multicast service. Those skilled in the art will appreciate that charges may be time-based, volume based, etc.

Thereafter, MSMF ensures that the mobile device 206, 208, 210 receives the content of the requested multicast service by first checking whether it already has joined the requested multicast service. This checking is accomplished by scanning through the first column 402 of the Table 400. If MSMF has already joined the requested service it is listed there and all what must be done is to register the mobile device 202, 206, 210 in the second column 404 and forward the service content to the new mobile device 202, 206, 210 in addition to the mobile devices that already receive the content.

If the requested service is not listed in the Table 400, MSMF registers for the multicast service. Registration is accomplished by sending out an IGMP “Join Group” message into the IP multicast enabled network via the BSR 202, 204 fixed network interface. Standard IETF multicast functionality ensures that the BSR 202, 204 receives the content for this newly joined multicast service from that point of time on. In addition, MSMF creates a new row in the Table 400 with the just joined service (e.g., multicast service 3) and the corresponding mobile device 206, 208, 210. Thereafter, MSMF controllably passes the content of the new multicast service in an appropriate manner to the requesting mobile device 206,208,210.

This on-demand registration for multicast services by MSMF ensures that only requested multicast service content is sent to the BSR 202, 204 by the IP multicast network. Limiting the amount of content that is delivered to the BSR 202, 204 is advantageous in that the link between the BSR 202 and IP network is potentially a low capacity link. Similarly, MSMF is configured to leave a multicast service when it is not needed anymore. When a mobile device 206, 208, 210 wants to leave a multicast service, it sends a “leave multicast service” message to the MSMF of the BSR 202, 204 to which it is connected. When MSMF receives such a message, it removes the mobile device 206, 208, 210 from the just-canceled multicast service in the Table 400 and stops forwarding the service content to that mobile device 202, 204. If the removed mobile device 202, 204 was the last one registered for the multicast service, the whole service row is removed, and MSMF sends out an IGMP “Leave Group” message to the IP multicast network. Thereafter, the BSR 202, 204 does not receive content of the just canceled multicast service anymore.

In the exemplary embodiments of the instant invention discussed above, only static user behavior has been discussed. Nevertheless, the instant invention is applicable to dynamic user behavior that involves the mobile devices moving between the BSRs 202, 204, which is generally considered to be normal behavior in a BSR/UMTS network. The instant invention supports mobility for registered users of multicast service. The scheme is transparent to the mobile device 206, 208, 210. During hard handover execution in a BSR environment, mobile specific information is exchanged between the old and the target BSR. To support seamless handover execution for multicast services, mobile specific multicast service information is exchanged between the MSMFs in the old and the target BSR. The exchanged information includes the multicast services that the mobile device is registered to and the charging information.

When the target BSR receives the multicast services that a user is connected or registered to, it adds these services into its own multicast service table 400 in the same way as described above in conjunction with addition of a new multicast service in a static environment. Therefore, the target BSR now provides the mobile device's multicast services and is prepared in advance when the mobile device then finally is connected to the target BSR. Thus the BSR multicast function is used during hand offs as well. Charging is continued based on the received charging information. Finally the target BSR informs the old BSR that it can remove the user's multicast service from its multicast service table. This removing function may be accomplished in substantially the same way as described above for the case when a user deregisters from a multicast service in a static environment.

Presently, the BSR network uses dedicated radio channels on the air interface. However in the backbone network, commercial off-the-shelf (COTS) IP multicast routers are deployed. Furthermore COTS streaming servers can be deployed.

In the future, the upcoming HSDPA implementations will further improve the efficiency and can be readily employed in the BSR architecture as well. Also in the future when 3GPP standardized MBMS implementations do exist in the years 2007/2008, MBMS radio bearers can be implemented in the air interface of the BSR nodes as well. As long as MBMS capable mobile devices are not available, current existing user equipment (UE) can be used.

Standard mobile devices (UMTS Rel.99 UEs) can be used in the instant invention to request multicast services. It is not required that a mobile device connecting to a multicast service have an IGMP protocol stack running. The only requirement of the mobile device is that it is possible to employ a software client on the mobile device for communication with the BSR MSMF function. But this requirement is already needed anyway for the mobile device to be capable of selecting and requesting the multicast service.

In the example described above it is assumed that the user has some kind of contract with his mobile operator regarding the multicast services he is allowed to receive and the corresponding billing associated with the different services. Such information is then stored on the Service Authentication Server 212.

The described architecture is also capable of supporting multicast advertisement services. Generally, the MSMF function in a BSR sends service advertisements to the mobile device's software client. The mobile client software can dynamically request advertised services from the MSMF. In that case also billing information may be provided and used by the MSMF.

Those skilled in the art will appreciate that a mobile device is capable of requesting more than one multicast service at a time. Further, it will be appreciated that the MSMF function can also be used to coordinate the delivery of broadcast services.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 220 causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method, comprising:
receiving content from an internet protocol multicast server at a base station router; and
passing the received content over an air interface to a mobile device.

2. A method, as set forth in claim 1, wherein receiving content from the internet protocol multicast server at the base station router further comprises receiving content from the internet protocol multicast server at the base station router in response to the base station router delivering a request for the content to the internet protocol multicast server.

3. A method, as set forth in claim 2, wherein receiving content from the internet protocol multicast server at the base station router in response to the base station router delivering a request for the content to the internet protocol multicast server further comprises the base station router delivering the request for the content in response to the mobile device sending a request for the content to the base station router.

4. A method, as set forth in claim 3, further comprising a plurality of mobile devices communicating with the base station router and wherein passing the received content over the air interface to the mobile device further comprises passing the received content over the air interface to only the mobile device requesting the content.

5. A method, as set forth in claim 3, further comprising the base station router discontinuing passing the received content over the air interface to the mobile device in response to the mobile device sending a request to the base station router to discontinue receiving the content.
